(19) United States
(12) Patent Application Publication
(10) Pub. No.: US 2022/0347928 A1
(43) Pub. Date: Nov. 3, 2022

(54) ADDITIVE MANUFACTURING SYSTEM FOR LIGHTWEIGHT LARGE SCALE SANDWICH STRUCTURES WITH TAILORABLE CORE DENSITIES

(71) Applicant: Raytheon Company, Waltham, MA (US)

(72) Inventors: Andrew Truxel, Hermosa Beach, CA (US); Curtis B. Carlsten, Seekonk, MA (US); Florian P. Lukowski, JR., El Segundo, CA (US)

(73) Assignee: Raytheon Company, Waltham, MA (US)

(21) Appl. No.: 17/244,506

(22) Filed: Apr. 29, 2021

(51) Int. Cl. B29C 64/393; B33Y 30/00; B33Y 50/02; B33Y 70/00; B29C 64/314; B33Y 40/10; G06F 30/23

(52) U.S. Cl. CPC B29C 64/393; B33Y 30/00; B33Y 50/02; B33Y 70/00; B29C 64/314; B33Y 40/10; G06F 30/23; B33Y 10/00

(57) ABSTRACT

A method of additive manufacturing including generating a stress model driven slice file for a structure and additively manufacturing a variable density foam core with respect to the stress model driven slice file such that a density of the variable density foam core is varied relative to a modeled stress in the structure manufactured with the variable density foam core. An additively manufactured structure includes a composite skin bonded to the variable density foam core.

### BACKGROUND

The present disclosure relates to additive manufacturing and, more particularly, to large format additive manufacturing systems in which an additive manufacturing stress model driven slice file provides a strategy for printing variable density foam cores.

Various manufacturing techniques exist to manufacture large scale structures. Recently, additive manufacturing has been adapted to form large scale structures. Such large scale additive manufactured structures have heretofore been relatively heavy and complicated to produce.

### SUMMARY

A method of additive manufacturing according to one disclosed non-limiting embodiment of the present disclosure includes generating a stress model driven slice file for a structure; and additively manufacturing a variable density foam core with respect to the stress model driven slice file such that a density throughout the variable density foam core is varied relative to a modeled stress in the structure manufactured with the variable density foam core.

A further aspect of the present disclosure includes additively manufacturing the variable density foam core to a near net shape.

A further aspect of the present disclosure includes that the variable density foam core is manufactured of a chemical foaming agent that generates an endothermic reaction.

A further aspect of the present disclosure includes that additively manufacturing the variable density foam core comprises adding a selected quantity of a foaming agent to a resin in a ratio with respect to the stress model driven slice file to vary the density throughout the variable density foam core.

A further aspect of the present disclosure includes modeling stress in the structure via Finite Element Analysis; and varying the density throughout the variable density foam core utilizing the stress model driven slice file in response to the modeled stress.

A further aspect of the present disclosure includes that the stress model driven slice file drives density toward zero at zero stress areas in the variable density foam core.

A further aspect of the present disclosure includes that the stress model driven slice file maintains an original geometric form of the variable density foam core at the zero stress areas.

A further aspect of the present disclosure includes that the stress model driven slice file relates a 3D stress field in the structure to the density via a look-up table.

An additive manufacturing system for additive manufacturing of a variable density foam core according to one disclosed non-limiting embodiment of the present disclosure includes a control system configured to control an extruder to additively manufacture a variable density foam core with respect to a stress model driven slice file such that a density throughout the variable density foam core is varied relative to a modeled stress in a structure manufactured with the variable density foam core.

A further aspect of the present disclosure includes a gravimetric blender in communication with a supply of resin and a supply of foaming agent; and a mixing nozzle in communication with the gravimetric blender and the extruder to dispense a selected ratio of the resin and foaming agent to continuously provide a desired density.

A further aspect of the present disclosure includes an expanding microsphere foaming media.

A further aspect of the present disclosure includes a die colorant in communication with the gravimetric blender, the die colorant associated with a density of the variable density foam core.

A further aspect of the present disclosure includes a look-up table that associates a 3D stress field in the structure to an associated density in the variable density foam core.

A further aspect of the present disclosure includes that the stress model driven slice file drives density in areas of the variable density foam core toward zero at zero stress areas in the structure.

An additively manufactured structure according to one disclosed non-limiting embodiment of the present disclosure includes a variable density foam core and a composite skin bonded to the variable density foam core.

A further aspect of the present disclosure includes that the density throughout the variable density foam core is commensurate with the stress in the associated areas in the structure.

A further aspect of the present disclosure includes that the density within the variable density foam core is almost zero at zero stress areas in the structure while an original geometric form of the variable density foam core is maintained.

A further aspect of the present disclosure includes a functional component embedded in the variable density foam core.

A further aspect of the present disclosure includes a multiple of die colorants in the variable density foam core, each color of the die colorant associated with the density of the variable density foam core.

A further aspect of the present disclosure includes that the variable density foam core is additively manufactured to a near net shape.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The structures in the drawings are not necessarily to scale. Moreover, in the drawings, like reference numerals designate corresponding parts throughout the several views. The drawings that accompany the detailed description can be briefly described as follows:

FIG. 1 is a schematic representation of an additive manufacturing system.

FIG. 2 is a block diagram of a method to additively manufacture a variable density foam core in accords with a stress model driven slice file.

FIG. 3 is a schematic representative of the method to additively manufacture a variable density foam core with respect to the stress model driven slice file.

FIG. 4 is a sectional view of a component with a variable density foam core.

FIG. 5 is a schematic view of a stress model of a structure with the variable density foam core.

### DETAILED DESCRIPTION

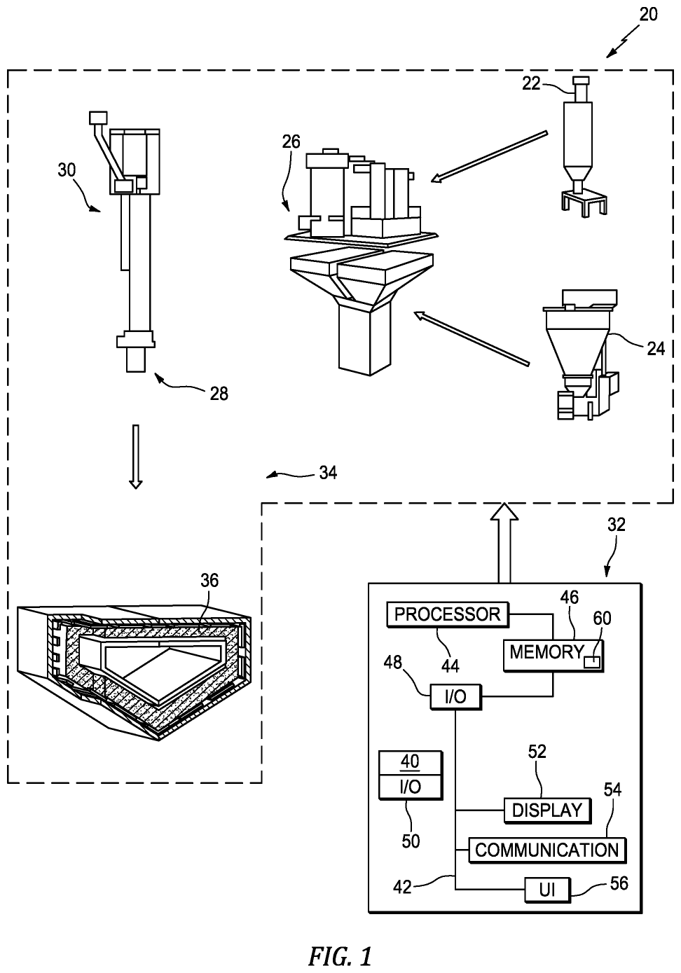

FIG. 1 schematically illustrates an additive manufacturing system 20 that may have particular applicability to an additive manufacturing process that can quickly and cost effectively produce large scale structures such as, for example only, vehicle bodies, boat hulls, support structures, shelter structures, etc., that are in the tens to hundreds of feet in size. Although particular structures may be referenced herein to provide a sense of scale, the additive manufacturing system 20 is not limited to only such structures and various structures may be manufactured therefrom.

The system 20 includes a resin supply 22, a foaming agent supply 24, a gravimetric blender 26, a mixing nozzle 28, an extruder 30, and a control system 32. The gravimetric blender 26 mixes a selected ratio of the resin and foaming agent from the resin supply 22, and foaming agent supply 24 for communication to the extruder 30. Various thermoplastic feed stocks (i.e., “resin”) such as, ABS, polycarbonate, polystyrene, other material such as slip agent, colorant, and foaming material such as chemical foaming agent, expanding microspheres, nitrogen, etc. that may be mixed by the gravimetric blender 26.

The gravimetric blender 26 receives a multiple of material in-feeds to form custom blending ratios such that a custom batch of material may be mixed then communicated to the extruder 30. Then, the gravimetric blender 26 immediately permits the blending of the next custom batch to be delivered to the extruder 30. That is, the gravimetric blender 26 essentially provides a continuous continually variable ratio of medias.

The mixing nozzle 28 is located at a tip of the extruder 30 to receive the desired ratio of material provided by the gravimetric blender 26. The material is transported to the extruder 30 where it may then be further mixed via rotation of an extruder screw. The thermoplastic resin may also be melted by heaters in the extruder 30 and the heat generated by the compression induced by the extruder screw. The extruder 30 is thereby provided with a continuous flow of material at the desired ratio of constituents. The extruder 30 is movable within a process space 34 in which a variable density foam core 36 is grown under command of the control system 32.

The control system 32 may include hardware, firmware, and/or software structures that are configured to perform the functions disclosed herein, including the generation of a stress model driven slice file 40 via logic 60. While not specifically shown, the control system 32 may include other devices, e.g., servers, mobile computing devices, computer aided manufacturer (CAM) systems, etc., which may be in communication with each other via a communication network 42 to perform one or more of the disclosed functions.

The control system 32 may include at least one processor 44, e.g., a controller, microprocessor, microcontroller, digital signal processor, etc., a memory 46, and an input/output (I/O) subsystem 48. The control system 32 may be embodied as any type of computing device e.g., a server, an enterprise computer system, a network of computers, a combination of computers and other electronic devices, or other electronic devices. Although not specifically shown, the I/O subsystem 48 typically includes, for example, an I/O controller, a memory controller, and one or more I/O ports. The processor 44 and the I/O subsystem 48 may be communicatively coupled to the memory 46. The memory 46 may be embodied as any type of computer memory device (e.g., volatile memory such as various forms of random access memory).

The I/O subsystem 48 may be communicatively coupled to a number of hardware, firmware, and/or software structures, including a data storage device 50, a display 52, a communication subsystem 54, and a user interface (UI) subsystem 56. The data storage device 50 may include one or more hard drives or other suitable persistent storage devices, e.g., flash memory, memory cards, memory sticks, and/or others to store the stress model driven slice file 40 and other data to operate the system 20. The display 52 may be embodied as any type of digital display device, touchscreen, etc. The display 52 is configured or selected to be capable of displaying two- and/or three-dimensional graphics. The communication subsystem 54 may include one or more optical, wired, and/or wireless network interface subsystems, cards, adapters, or other devices, as may be needed pursuant to the specifications and/or design of the particular computing device. The user interface subsystem 56 may include one or more user input devices, a touchscreen, keyboard, virtual keypad, etc. and one or more output devices, e.g., speakers, displays, etc.

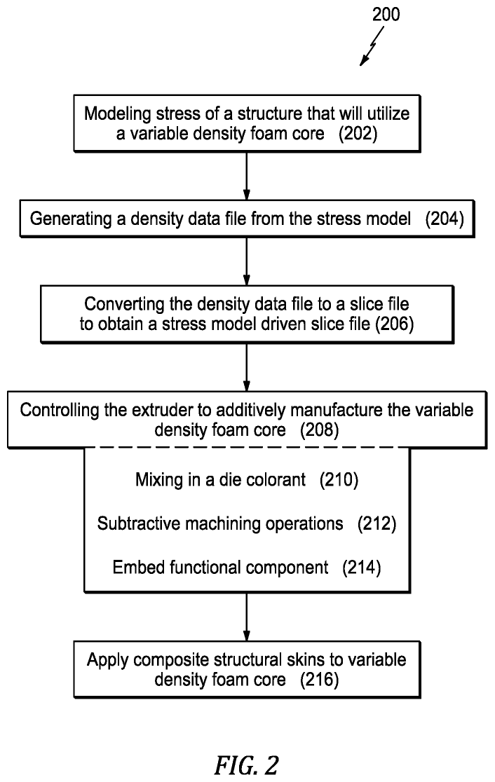

With reference to FIG. 2, the control system 32 executes logic 60 (FIG. 1) representative of a method 200 actively governed by the stress model driven slice file 40 to additively manufacture the variable density foam core 36. The functions of the method 200 are disclosed in terms of functional block diagrams, and it should be appreciated that these functions may be enacted in either dedicated hardware circuitry or programmed software routines capable of execution in a microprocessor-based electronics control embodiment.

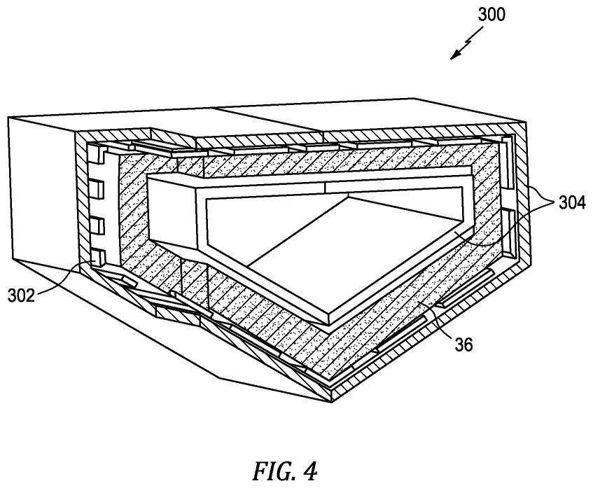

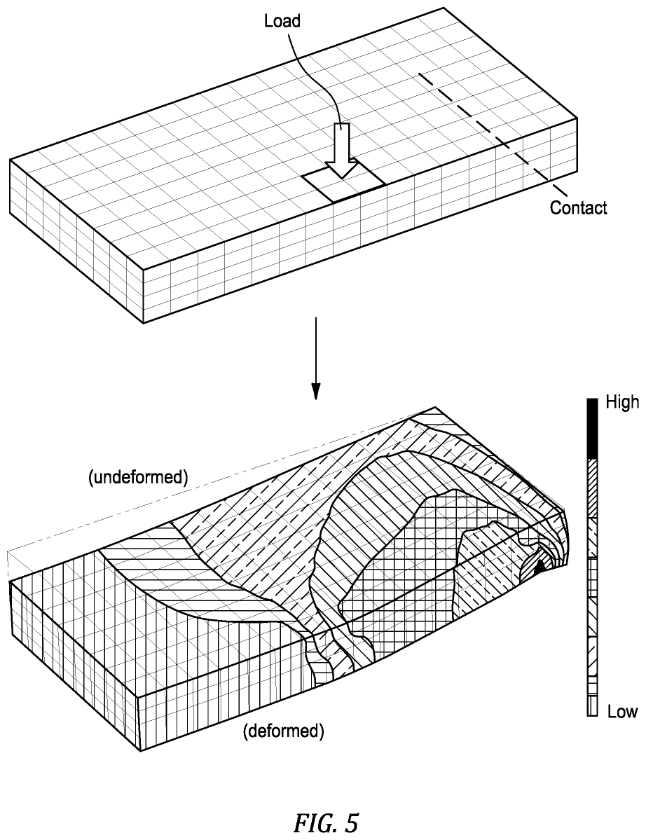

The method 200 is initiated by modeling of the stress (202) of a structure 300 (FIG. 4) that will utilize the variable density foam core 36 to generate a stress model (FIG. 5). The expected stress in the structure that will utilize the variable density foam core 36 may be performed, for example, by Finite Element Analysis software.

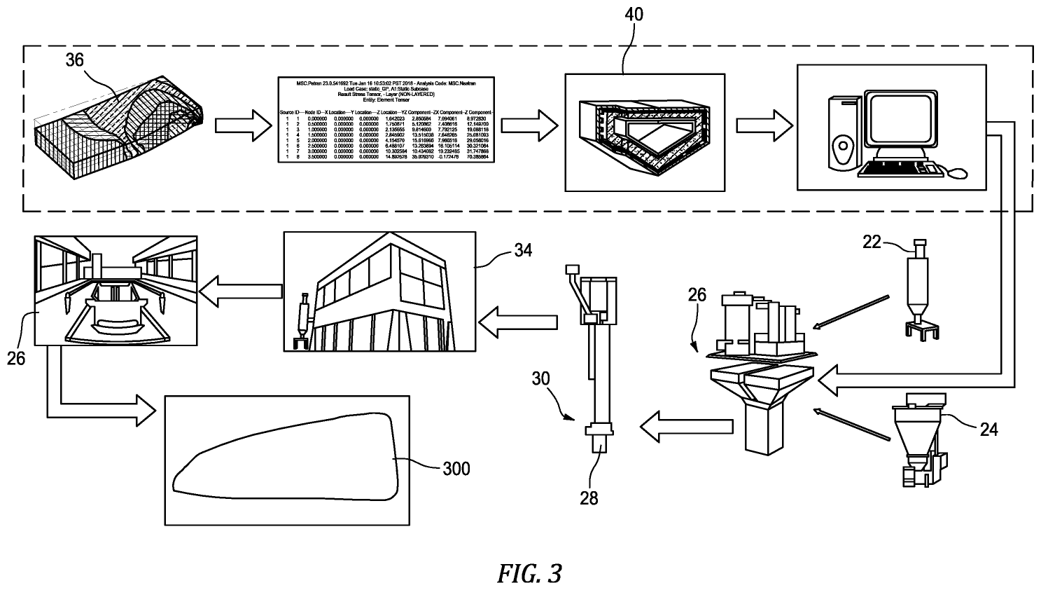

Next, a density data file (204; FIG. see also FIG. 3) is generated from the stress model by relating the modeled 3-dimensional stress fields in the structure 300 that utilizes the variable density foam core 36 to a desired density throughout the variable density foam core 36. The desired density may be determined via a look-up table, algorithm, or other such predetermined relationship that recommends a desired density for a particular stress. The density data file may segregate the structure 300 into cells, (e.g., a 4×4×1 inch (102×102×25 mm) cell) then determine what density is required within each cell. This segregation of each cell of the additive manufacturing extruder path allows for a unique density throughout the variable density foam core 36 and within each cell.

Next, the density data file is inputted to the slicer software, for example G-code machine command (computer numerical control (CNC) programming language) generation as embodied by the slice file output (206; FIG. see also FIG. 3). The slicer software slices the 3D part geometry into vertically stacked layers (Z-direction), and defines the horizontal (X-Y) path of material deposit from the extruder 30, and integrates commands to vary the extrudate density along the additive manufacturing extruder path in accords with the stress model driven slice file 40. That is, the three-dimensional density data file is converted into a plurality of slices, each slice defining a cross section of the variable density foam core 36. The stress model driven slice file 40 is essentially the machine code (e.g., G-code) which provides the additive manufacturing machine commands in an X-Y-Z reference frame and a feed rate of the additive material. The variable density foam core 36 is then “grown” slice-by-slice, or layer-by-layer as a bead or extrudate along the extruder path until complete. The Z-direction slices and X-Y direction extrudate deposition is one example of variable density foam core manufacturing as performed by an additive manufacturing machine with X-Y-Z, 3-degree of freedom. However, additive manufacturing systems equipped and configured with more than 3 degrees of freedom may deposit extrudate in free-form fashion and are not restricted to slices and extrudate that are related and constrained by orthogonal planes. Additive manufacturing machines with more than three degrees of freedom are driven by G-code containing slice files created by slicing software configured to generate out of plane extrusion paths.

The control system 32 is configured to control the extruder 30 to additively manufacture the variable density foam core 36 with respect to the stress model driven slice file 40 such that a density of the variable density foam core 36 is varied relative to a modeled stress in the structure 300 manufactured with the variable density foam core 36 (208). The stress model driven slice file 40 is used by the control system 32 to generate the process parameters to additively manufacture the variable density foam core 36.

The stress model driven slice file 40 also identifies the density transitions that are to be within the variable density foam core 36 (FIG. 5). For example, a high density foam can be dispensed near stress concentrations such as attachment hardpoints and a low density foam in areas under little to no loading, with a gradient density therebetween. The extruder path from the stress model driven slice file 40 for the variable density foam core 36 may be created, then segregated along cells, then the material density transition defined between each cell on each layer. The result will be the stress model driven slice file 40 that the extruder 30 can read and use to properly define the path that forms the variable density foam core 36 while communicating with the gravimetric blender 26 as to the ratio of material required within the variable density foam core 36. The gravimetric blender 26 and extruder 30 pathing is controlled so that the correct materials are blended at the proper time during the build sequence. The variable density foam core 36 may be additively manufactured by the extruder 30 which transits along a bead path in which one bead next to another may be of varying density to change the density in a transverse direction. The dispensed beads need not necessarily be in a 100% orthogonal X-Y-Z direction but can alternatively be in other directions that conform with the geometry of the component. That is, the slicer file can convert the variable density foam core 36 into cubic cells in which each cell is associated with a desired density which are then constructed via the beads dispensed by the extruder 30. The cells can be connected by a continuous extrusion bead, that may be of constant or varying density. Alternatively, the cells may of different densities to form a density gradient, but not from a contiguous bead (i.e., cells with a specific density are filled, then cells with the next incremental density are filled, until the entire 3-D density filed is filled, thereby creating a contiguous volume of variable density foam, but not with a continuous bead).

The stress model driven slice file 40 may drive the density within the variable density foam core 36 toward zero at zero stress areas in the variable density foam core 36 while maintaining the desired geometric form. Generally, the quantity of voids in the variable density foam core 36 may be controlled by the quantity of the foaming agent communicated to the extruder 30. The foaming agent may generate an endothermic reaction or may contain microspheres to facilitate formation of foam with upwards of the variable density foam core 36 with upwards of 85% void content. The void content may be limited by the maximum achievable void content (i.e., gas bubbles) in the thermoplastic resin. The foam density is thus controlled at the discrete cellular level. Chemical foaming agents and expanding microspheres are proportionally mixed with the thermoplastic resin in the gravimetric blender 26. Nitrogen is mixed with the thermoplastic resin directly in the extruder barrel.

The stress model driven slice file 40 may also define a die colorant that is mixed in at the gravimetric blender 26 (210). Each color of the die colorant may be associated with the density throughout the variable density foam core 36 to provide a visual indication of the foam density utilized throughout the variable density foam core 36, e.g., high density areas are dark red, lesser dense areas are light red, down to near zero density areas being dark blue with a range of colors therebetween. This facilitates later visual inspection.

The variable density foam core 36 manufactured by the system 20 provides a near net shape. That is, the variable density foam core 36 may provide a slight overbuild or machine stock, for the variable density foam core 36 that may later require only minor subsequent subtractive machining operations (212) to obtain the final shape. At about 85% void content, the densities are low enough to be competitive with commercial blocks of foam but are produced at near net shaped variable density.

A functional component 302 (FIG. 4) such as a sensor, insert, conduit, ballistic plates, etc., may also be embedded (214) in the variable density foam core 36 during extrusion. The slice file G-code can be created with pauses in the machine operation to allow the functional component 302 to be inserted into the part between layers. The geometry of the variable density foam core 36 can thereby be printed to provide conformal cavities within the functional component 302.

Next, composite structural skins 304 (FIG. 4) are applied (216) to the variable density foam core 36 to provide a stress optimized inexpensive, lightweight, structure. The variable density foam core 36 serves as a volumetric form around which a high strength fabric/resin matrix skin is wrapped. Standard sandwich foam core composite manufacturing methods do not readily permit the insertion of non-foam parts that increase the overall functionality of the final structure.

The extrusion process facilitates fabrication of large scale, near-net shape variable density foam cores for composite structures without molds at lower cost, weight, and lead-time compared to traditional processes.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A method of additive manufacturing, comprising:
generating a stress model driven slice file for a structure; and
additively manufacturing a variable density foam core with respect to the stress model driven slice file such that a density throughout the variable density foam core is varied relative to a modeled stress in the structure manufactured with the variable density foam core.

2. The method as recited in claim 1, further comprising additively manufacturing the variable density foam core to a near net shape.

3. The method as recited in claim 2, wherein the variable density foam core is manufactured of a chemical foaming agent that generates an endothermic reaction.

4. The method as recited in claim 1, wherein additively manufacturing the variable density foam core comprises adding a selected quantity of a foaming agent to a resin in a ratio with respect to the stress model driven slice file to vary the density throughout the variable density foam core.

5. The method as recited in claim 4, further comprising:
modeling stress in the structure via Finite Element Analysis; and
varying the density throughout the variable density foam core utilizing the stress model driven slice file in response to the modeled stress.

6. The method as recited in claim 1, wherein the stress model driven slice file drives density toward zero at zero stress areas in the variable density foam core.

7. The method as recited in claim 6, wherein the stress model driven slice file maintains an original geometric form of the variable density foam core at the zero stress areas.

8. The method as recited in claim 7, wherein the stress model driven slice file relates a 3D stress field in the structure to the density via a look-up table.

9. An additive manufacturing system for additive manufacturing of a variable density foam core, comprising:
an extruder; and
a control system configured to control the extruder to additively manufacture a variable density foam core with respect to a stress model driven slice file such that a density throughout the variable density foam core is varied relative to a modeled stress in a structure manufactured with the variable density foam core.

10. The system as recited in claim 9, further comprising:
a gravimetric blender in communication with a supply of resin and a supply of foaming agent; and
a mixing nozzle in communication with the gravimetric blender and the extruder to dispense a selected ratio of the resin and foaming agent to continuously provide a desired density.

11. The system as recited in claim 10, wherein the foaming agent generates an endothermic reaction or contains microspheres.

12. The system as recited in claim 10, further comprising a die colorant in communication with the gravimetric blender, the die colorant associated with a density of the variable density foam core.

13. The system as recited in claim 10, further comprising a look-up table that associates a 3D stress field in the structure to an associated density in the variable density foam core.

14. The method as recited in claim 13, wherein the stress model driven slice file drives density in areas of the variable density foam core toward zero at zero stress areas in the structure.

15. An additively manufactured structure, comprising:
a variable density foam core; and
a composite skin bonded to the variable density foam core.

16. The structure as recited in claim 15, wherein the density throughout the variable density foam core is commensurate with the stress in the associated areas in the structure.

17. The structure as recited in claim 15, wherein the density within the variable density foam core is almost zero at zero stress areas in the structure while an original geometric form of the variable density foam core is maintained.

18. The structure as recited in claim 15, further comprising a functional component embedded in the variable density foam core.

19. The structure as recited in claim 15, further comprising a multiple of die colorants in the variable density foam core, each color of the die colorant associated with the density of the variable density foam core.

20. The structure as recited in claim 15, wherein the variable density foam core is additively manufactured to a near net shape.
